(19) United States
(12) Patent Application Publication
(10) Pub. No.: US 2011/0313824 A1
(43) Pub. Date: Dec. 22, 2011

(54) Method for Applying Gaming Philosophy to Crowd-Sourced Play-Listing

(76) Inventor: MARCOS LARA, NEW YORK, NY (US)

(21) Appl. No.: 12/964,519

(22) Filed: Dec. 9, 2010

Related U.S. Application Data
(60) Provisional application No. 61/285,146, filed on Dec. 9, 2009.
(60) Provisional application No. 61/321,443, filed on Apr. 6, 2010.
(60) Provisional application No. 61/323,540, filed on Apr. 13, 2010.
(60) Provisional application No. 61/323,456, filed on Apr. 13, 2010.

(51) Int. Cl. G06Q 30/00; G06F 15/16

(52) U.S. Cl. 705/14.1; 705/1.1; 705/319

(57) ABSTRACT

A method of motivating crowd-sourcing of performance playlists. Two or more users may initiate an exchange of metadata related to playlists via playlist managing software modules running on each of their mobile devices. The users may then receive a reward for having initiated the exchange. The reward may be in the form of a position on a leader board, a level of achievement, an unlocking of an achievement, a badge acknowledging an achievement, a designation of a title an amount of points or some combination thereof. The initiation of the exchange may itself include a game like element and may require each of the mobile devices to be in the same geographical location, and then have the users, simultaneously move them in a predetermined pattern such as a shaking motion.

### CLAIM OF PRIORITY

This application claims priority to U.S. Provisional Patent No. 61/285,146 entitled “Sharing Metadata on Mobile Platforms” filed on Dec. 9, 2009, the contents of which are fully incorporated herein by reference. This application also claims priority to U.S. Provisional Patent No. 61/321,443 entitled “Metadata combination for serialized content delivery to “N” users” filed on Apr. 6, 2010, U.S. Provisional Patent No. 61/323,540 entitled “Authentication System for a Mobile-enabled data sharing application” filed on Apr. 13, 2010 and to U.S. Provisional Patent No. 61/323,456 entitled “Vertical Neutral “N” User Metadata Comparisons” filed on Apr. 13, 2010 the contents of all of which are fully incorporated herein by reference.

### FIELD OF THE INVENTION

The invention relates to computer implemented methods for motivating user participation, and more particularly, to a computer implanted method of applying gaming philosophy to crowd-sourced play-listing.

### BACKGROUND OF THE INVENTION

Game mechanics is a term used to describe the deliberate construction of rules of play intended to produce an enjoyable game or game play. With the proliferation of social networking sites, it has become fashionable to attempt to combine the elements of game mechanics with Internet applications to attempt to both advertise the existence of a product or brand and to create a base of loyal users of the product or brand.

A problem with applying this philosophy to marketing most products is in defining a game to be played. The most successful use of game mechanics appears to have been in creating an audience for online participation games such as, but not limited to, Farmville™. It is, however, a virtual game, and as such has limited use in marketing real world products or services.

The method of this invention overcomes this and related problems with applying game mechanics to marketing real products by making the act of consumption of the service being marketed the game, or an integral element of achieving success in the game.

Crowd-sourcing playlists is a term that may be used to describe obtaining lists of performances of interest from peers rather than any single large database. In the context of music, crowd-sourcing of playlists may be considered to be sharing songs that one has discovered with one's friends or acquaintances having a similar taste in music.

An objective of the present invention may be considered to be motivating users to participate in the crowd-sourcing by playlists by providing gaming mechanics that essentially rewards the participation in creating, or use of, the crowd-sourced lists.

### DESCRIPTION OF THE RELATED ART

The relevant prior art involving the application of gaming philosophy includes:

U.S. Pat. No. 7,216,870 issued to Bess, et al. on May 15, 2007 entitled “Resource point game mechanic” that describes a resource point game mechanic that includes a plurality of game components, at least some of which have a resource point value. Each game component is in a state such as an “in play” state or an “out of play” state. Resource points according to the resource point value are accumulatable by a player transitioning one of the game components from the “out of play” state to the “in play” state. Preferably, the resource points are spendable on benefits/chances/penalties. An alternative preferred embodiment of the present invention is a method for using a game mechanic in which each player obtains a plurality of game components having a resource point value, then each player, in turn, transitions at least one of the game components from an “out of play” state to an “in play” state, and then each player accumulates resource points according to the resource point value by the step of transitioning.

US Patent Application no 20090017886 by McGucken published on Jan. 15, 2009 entitled “System and method for creating exalted video games and virtual realities wherein ideas have consequences” that describes a video game method and system for creating games where ideas have consequences, incorporating branching paths that correspond to a player's choices, wherein paths correspond to decisions founded upon ideals, resulting in exalted games with deeper soul and story, enhanced characters and meanings, and exalted gameplay. The classical hero's journey may be rendered, as the journey hinges on choices pivoting on classical ideals. Ideas that are rendered in word and deed will have consequences in the gameworld. Historical events such as The American Revolution may be brought to life, as players listen to famous speeches and choose sides. As great works of literature and dramatic art center around characters rendering ideals real, both internally and externally, in word and deed, in love and war, the present invention will afford video games that exalt the classical soul, as well as the great books, classics, and epic films—past, present, and future.

US Patent Application no. 20100306656 by Moloney et al. published on Dec. 2, 2010 entitled “Digital media asset management” that describes a system and a method for managing a plurality of video assets via code executing in a processor. The system and method include a user interface, a controller configured to receive metadata associated with the plurality of video assets through the user interface, a database communicatively coupled to the controller in order to store the metadata, a sequence generator communicatively coupled to the database to generate a playlist from the metadata, a generator module communicatively coupled to the sequence generator module, wherein the generator module is configured to generate a uniform resource locator address (URL) that points to a playlist comprising related video assets and a communications module for providing the URL to a remote machine.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to a method of motivating crowd-sourcing of performance playlists. In a preferred embodiment, two or more mobile electronic devices are each provided with an operative performance playlist managing software module, or application. Users of the device may then initiate a play-list exchange between them, and then receive a reward for having initiated the exchange.

In a preferred embodiment, the reward may, for instance, be a game mechanics type reward such as, but not limited to, a change in position on a leader board, a change in a level of an achievement, an unlocking of an achievement, a badge acknowledging an achievement, a designation of a title an amount of points or some combination thereof.

The initiation of the exchange may itself include a game like element and may, for instance, require each of the mobile devices to be in substantially the same geographical location, and then have the users, substantially simultaneously, move them in a predetermined pattern, that may for instance be a shaking motion.

The mobile electronic devices, or there users, may each have a status that may, for instance, be dependent on a factor related to crowd-sourcing of the playlists such as, but not limited to, a current geographical location, a number of previous initiations by at least one of the mobile electronic devices, a number of previous initiations by at least one of the mobile electronic devices at substantially the current geographical location, a size of at least one of the play-list meta-data files, or some combination thereof.

The reward may include a component that is dependent on the status of one or other of the participants in the exchange, it may have a component dependent of some combination of there status such as, but not limited to, a sum or a difference of their status.

In a further preferred embodiment, the reward may, for instance, be displayed on one or more of the user's social network sites, or on another publically or privately accessible webpage.

In a further preferred embodiment, it may be possible to exchange the reward, in whole or in part, for a service such as, but not limited to, to free or reduced fee access to a performance URL.

Therefore, the present invention succeeds in conferring the following, and others not mentioned, desirable and useful benefits and objectives.

It is an object of the present invention to provide a game mechanic incentive to participate in crowd-sourcing performance playlists.

It is another object of the present invention to provide game mechanic rewards for participation in, or the use of, crowd sourced playlists.

Yet another object of the present invention is to provide means to incorporate social network sites into crowd-sourcing performance playlists.

### BRIEF DESCRIPTION OF THE DRAWINGS

FIG. 1 shows a schematic overview of a system for crowd sourcing performance playlists in accordance with a preferred embodiment of the present invention.

FIG. 2 shows a flow diagram of steps that may be taken to crowd sourcing performance playlists in a preferred embodiment of the present invention.

FIG. 3 shows a more detailed flow diagram of steps that may be taken to crowd sourcing performance playlists in a preferred embodiment of the present invention.

FIG. 4 shows a schematic interaction diagram showing interactions that may occur in crowd sourcing performance playlists in a preferred embodiment of the invention.

FIG. 5 shows a schematic interaction diagram showing interactions that may occur in implementing a preferred embodiment of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto. In particular, the following description of the present invention is presented as pertaining to the distribution, consumption and accounting for digital music. One of ordinary skill in the art will readily appreciate that the inventive concepts discussed below may readily be adapted for use in other digital media such as, but not limited to, text, images and video, or some combination thereof.

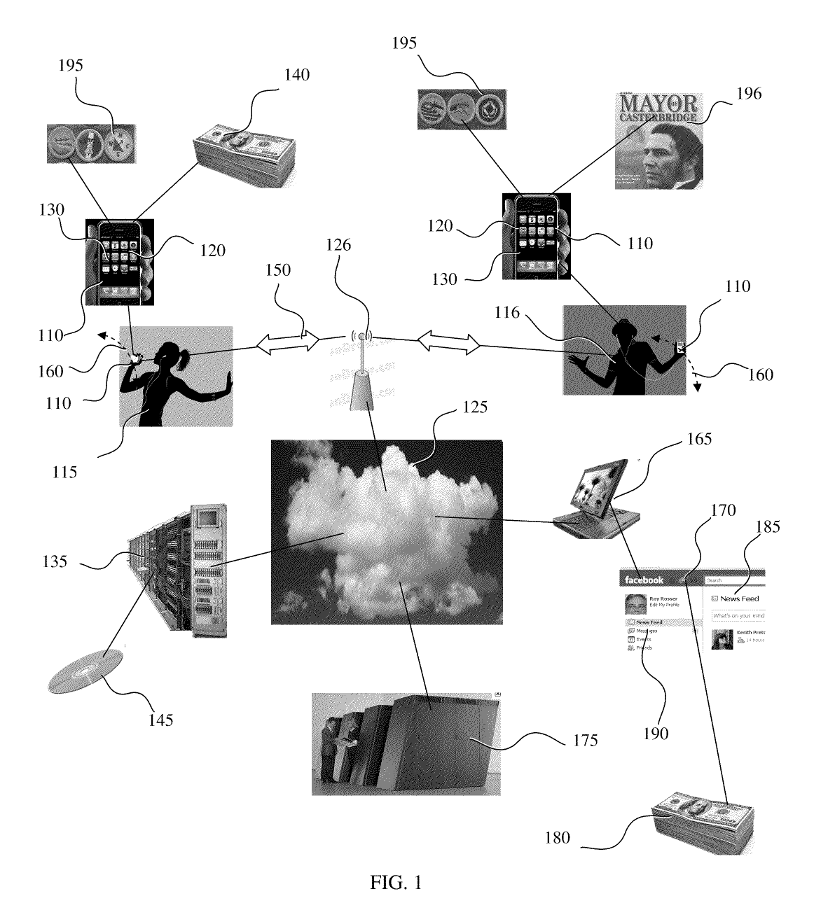

FIG. 1 shows a schematic overview of a system for crowd sourcing performance playlists in accordance with a preferred embodiment of the present invention.

As shown in FIG. 1, a 1st user's 115 and a 2nd user's 116 each have a mobile electronic device 110. The mobile electronic devices 110 may be used for communication or for accessing content such as, but not limited to, songs streamed from digital mechanical 145 via a 3rd party server 135 over the Internet 125 and suitable wireless transmission hardware 126.

Each of the users' mobile electronic devices 110 may have an operative performance playlist managing module 120 that may keep track of the music they prefer to listen to. The performance playlist managing module 120 may communicate with a network server 175. The network server 175 may facilitate communication between the mobile electronic devices 110 and may keep track of a user history of use.

The 1st user's 115 and 2nd user's 116 may initiate an automated exchange of data between their respective performance playlist managing modules 120. In a preferred embodiment, this exchange 150 may be limited to metadata associated with the playlists. This metadata may include URL's of sites that may host digital mechanicals 145 for the materials on the playlist. The exchange 150 may, however, involve no transfer of material capable of reproducing the performance on the digital mechanicals 145.

In return for initiating the exchange 150 of the play-list metadata files 130 the users may receive a reward from the network server 175. The reward may, for instance, be a game element reward such as, but not limited to, a change in position on a leader board 185, a change in a level of an achievement, an unlocking of an achievement 190, a badge acknowledging an achievement 195, a designation of a title 196, an amount of points or some combination thereof.

A leader board 185 in the context of game mechanics is a list of the top scorers in some event or contest. In the context of motivating crowd sourcing of performance playlists 100, there may for instance be multiple leader boards, one each for achievements such as, but not limited to, the most exchanges, the most playlists, the largest playlist, the most playlists exchanged in a certain location or range of locations, the most playlists exchanged at a certain time or date, or within a range of times or dates, the most playlists exchanged with new users to the service or some combination thereof.

An achievement may be when a metric reaches a certain threshold, such as, but not limited to, a first exchange, a 10^{th} exchange, an nth exchange, a first play list, a first exchange with a new user, a first exchange at a certain time or date, a first exchange in a certain location or venue, or some combination thereof.

A user status may, for instance, be a rank on a leader board, a metric related to the number and type of achievement or some combination thereof. The users status may also depend on items such as, but not limited to, a current geographical location, a number of previous initiations by at least one of the mobile electronic devices, a number of previous initiations by at least one of the mobile electronic devices at substantially the current geographical location, a size of at least one of said play-list meta-data files, or some combination thereof.

A badge may be graphic image, an audio file, a ring tone or any suitable digital mechanical, that may signify the attainment of an achievement.

A title may, for instance, be associated with a place, venue or establishment and may be conferred on a user who is the most frequent visitor to that place, or the one who has visited the most within a certain time span. The title may have a component dependent on gender, age or ethnicity, or some combination thereof. Examples of title include honorifics such as, but not limited to, mayor, emperor, king or queen.

In addition to being displayable on the performance playlist managing module 120, the rewards 140 may also be listed automatically, or voluntarily, on an independent website such as, but not limited to, a users social network home page.

In this way a user may track there achievements even when using their users PC or laptop 165.

The process of initiating the exchange 150 of a play-list meta-data file 130 may include elements such as, but not limited to, required that each of the mobile devices is in substantially the same geographical location and where each of the uses moves their mobile devices substantially simultaneously, in a predetermined pattern 160. This method of initiation is sometimes termed “shaking”. The predetermined pattern 160 may be individually stylized and may represent a user's “signature”. In a further preferred embodiment, initiating the predetermined pattern 160 may require one user to imitate another user's signature movement.

The network server 175 may facilitate exchanging the reward for a service such as, but not limited to, free or reduced prices access to a performance URL.

In a further preferred embodiment, initiating the play-list meta-data exchange may require each of the mobile devices to be in a different geographical location and where each of the mobile devices is, substantially simultaneously, moved in a predetermined pattern.

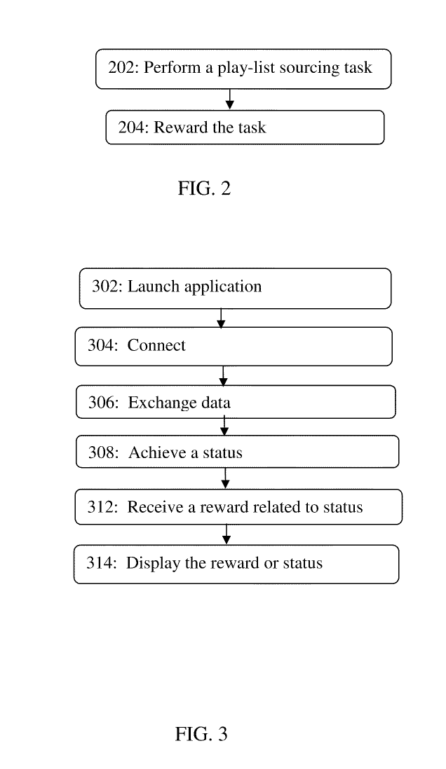

FIG. 2 shows a flow diagram of steps that may be taken to crowd sourcing performance playlists in a preferred embodiment of the present invention.

In Step 202: Perform a play-list sourcing task, a player may perform a task such as, but not limited to, initiating an exchange 150 of a play-list meta-data file 130 with another player.

In Step 204: Reward the task, the network server 175 may monitor the performance of the task, and may reward one or both of the users involved in the task by a method such as, but not limited to, delivering a digital mechanical of a badge, conferring a title, adjusting a user's position on a leader board, or adjusting a user's status or some combination thereof.

FIG. 3 shows a more detailed flow diagram of steps that may be taken to crowd sourcing performance playlists in a preferred embodiment of the present invention.

In Step 302: Launch application, the performance playlist managing module 120 may be launched on the mobile electronic devices 110.

In Step 304: Connect, a 1st user's 115 and a 2nd user's 116 may initiate a connection between the performance playlist managing modules 120 running on their mobile electronic devices 110. The connection may, for instance, be mediated by a network server 175 and may occur via the Internet 125.

In Step 306: Exchange data, the performance playlist managing modules 120 may exchange one or more play-list meta-data files 130.

In Step 308: Achieve a status, the network server 175 mediating the exchange 150 may adjust a status of one or both of the users.

In Step 312: Receive a reward related to status, the network server 175 may deliver a reward 140 to the users mobile electronic devices 110.

In Step 314: Display the reward or status, the user may, for instance, display their rewards or status, or all, on their mobile electronic devices 110. They may also, or instead, display their status and rewards on a third party web site such as, but not limited to, a social networking home or group page.

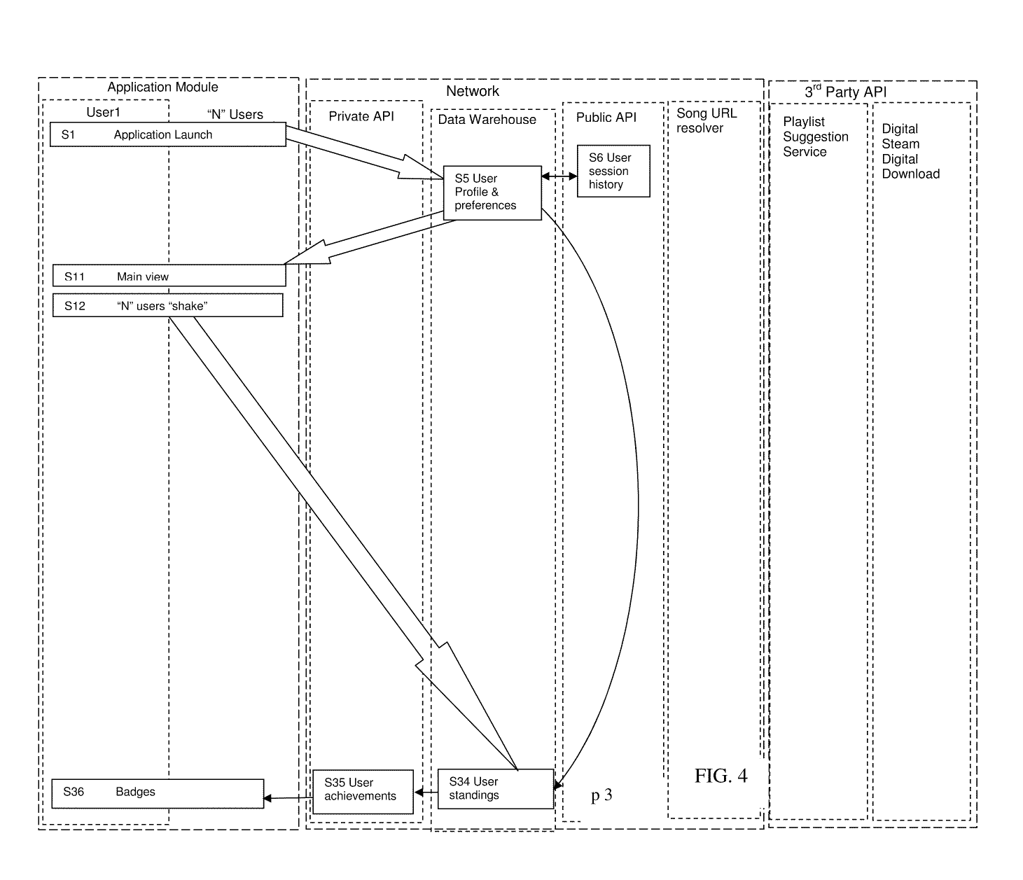

FIG. 4 shows a schematic interaction diagram showing interactions that may occur in crowd sourcing performance playlists in a preferred embodiment of the invention.

In Step S1, “Application Launch” the performance playlist managing module 120 may be started on each of the users' mobile electronic devices 110.

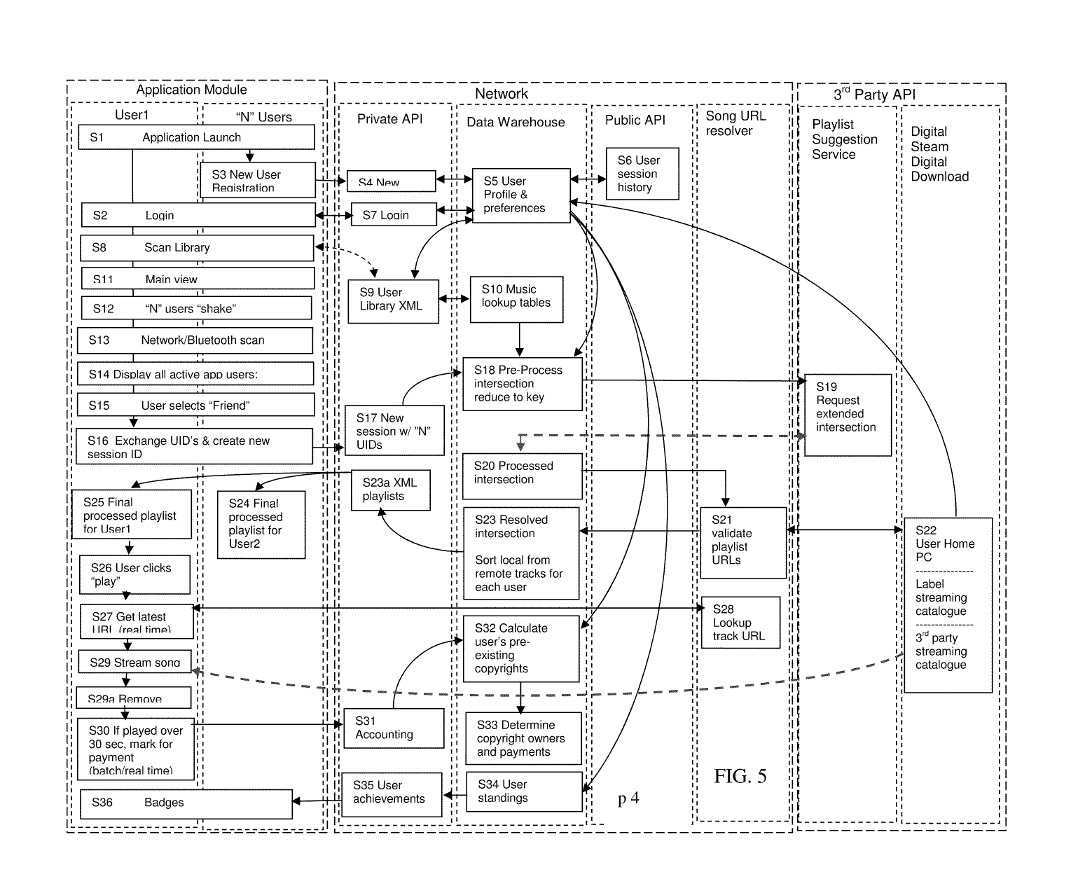

The modules may then proceed to Step S5 “User Profile & preferences” by intermediate steps shown in detail in FIG. 5. Step S5 may involve the 3rd party server 135 providing the modules with relevant data regarding their play lists and may involve Step S6 of “User session history”, in which their session history may be obtained.

The module may then proceed to Step S11 by intermediate steps shown in detail in FIG. 5. At Step S11 of “Main view”, the user may be shown their home page on the mobile electronic devices 110.

The users may then proceed to step S12 in which “N” users “shake”, i.e., the two users may initiate an exchange of playlist metadata.

The module may then proceed to Step S34 by intermediate steps shown in detail in FIG. 5. At Step S34 “User standings” each users standings may be examined and updated before proceeding to Step S35 “User achievements” where the updated achievements may be made available to the mobile electronic devices 110.

The performance playlist managing module 120 may then proceed to Step

If any badges need to be delivered to the user, this may be done in Step S36 “Badges”.

FIG. 5 shows a schematic interaction diagram showing interactions that may occur in implementing a preferred embodiment of the invention.

The steps relevant to method of motivating crowd sourcing of performance playlists 100 are described in detail above.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method of motivating crowd sourcing of performance playlists, said method comprising:
providing two or more mobile electronic devices each having an operative performance playlist managing module;
initiating a play-list meta-data file exchange between said two or more mobile electronic devices; and
receiving, by at least one of said mobile electronic devices, a reward related to initiating said exchange.

2. The method of claim 1 wherein initiating said play-list meta-data exchange comprises each of said mobile devices being in substantially a same geographical location and wherein each of said mobile devices is, substantially simultaneously, moved in a predetermined pattern.

3. The method of claim 1 further comprises recording a status of at least one of said mobile electronic devices.

4. The method of claim 3 wherein said reward comprises a component dependent on said status.

5. The method of claim 3 wherein said status comprises one of a current geographical location, a number of previous initiations by at least one of said mobile electronic devices, a number of previous initiations by at least one of said mobile electronic devices at substantially said current geographical location, a size of at least one of said play-list meta-data files, or some combination thereof.

6. The method of claim 1 wherein said reward is one of a change in position on a leader board, a change in a level of an achievement, an unlocking of an achievement, a badge acknowledging an achievement, a designation of a title, an amount of points or some combination thereof.

7. The method of claim 6 wherein said reward is displayed on a social network site.

8. The method of claim 6 wherein said reward may be exchanged for a service.

9. The method of claim 8 wherein said service comprises access to a performance URL.

10. The method of claim 1 wherein initiating said play-list meta-data exchange comprises each of said mobile devices being in a different geographical location and wherein each of said mobile devices is, substantially simultaneously, moved in a predetermined pattern.
